(19) United States
(12) Patent Application Publication
(10) Pub. No.: US 2025/0326964 A1
(43) Pub. Date: Oct. 23, 2025

(54) CLAY SWELLING INHIBITORS

(71) Applicant: PETRORAZA SAS, Envigado (CO)

(72) Inventors: Jose Edgar Patiño, Envigado (CO); Natalia Andrea Ospina, Envigado (CO)

(73) Assignee: PETRORAZA SAS, Envigado (CO)

(21) Appl. No.: 18/915,847

(22) Filed: Oct. 15, 2024

Related U.S. Application Data
(60) Provisional application No. 63/635,175, filed on Apr. 17, 2024.

(51) Int. Cl. C09K 8/16; B82Y 20/00; B82Y 40/00; C09K 11/65; C09K 11/87; E21B 21/06

(52) U.S. Cl. CPC C09K 8/16; C09K 11/65; C09K 11/87; E21B 21/062; B82Y 20/00; B82Y 40/00; C09K 2208/10; C09K 2208/12

(57) ABSTRACT

Novel clay stabilization compounds comprising metal-doped carbon quantum dots, methods of their manufacture, oilfield drilling fluid compositions containing the clay stabilization compounds and methods of their use are disclosed. The novel clay stabilization compounds are useful, inter alia, to reduce clay swelling in use, have higher penetration rates than oil-based fluids, are more environmentally acceptable, employable at much lower concentrations, are reusable, may be used in a wider range of drilling fluids including, for example, seawater-based drilling fluids and/or more cost-effective in use.

### FIELD OF THE INVENTION

The present invention relates to additives used in drilling fluids for providing improved drilling efficiencies in oil wells and related processes. The drilling efficiencies include an ability to stabilize clay(s) within the oil well during drilling and/or oil removal operations. More particularly, this invention relates to carbon quantum dot (CQD) compositions further comprising nickel and/or palladium nanoparticles having clay-swelling inhibition properties that enhance one or more drilling related oilfield processes.

### BACKGROUND OF THE INVENTION

To obtain the oil and related hydrocarbons entrapped below the earth's surface, wells are drilled into the formations, thereby contacting not only the rock formation, but also any clay contained therein. The drills require drilling fluids designed to facilitate penetration of the clay-contained rock typically carried out using a rotary drill bit within a pipe. The drilling fluids, by their very nature, may include a complex mixture of chemicals and carriers designed to address one or more functions of well drilling operations. These may include cooling and lubrication of the drill bit and/or removal of the drill's cuttings as they are formed. Some drilling fluid additives may provide stabilization to the walls of the well cut into and/or assist in providing a counterpressure to internal fluid pressures within the formation. Other additives may be added to allow the application of increased pressures within the formation as part of a fracking or fracturing process. To reduce the cost and environmental impact of drilling fluids in any of these applications, it is advantageous to recycle the fluids where possible.

Certain underground reservoirs of oil and gas reserves are located in sedimentary rock formations that may further contain one or more layers of clays. Clays contained in sedimentary rocks include, for example, one or more of smectites, montmorillonites, illites, micas, kaolinites and/or chlorites.

A clay's characteristics arise from its chemical composition, layered structure, and size. Generally speaking, clay minerals have a great affinity for water. As a clay adsorbs water within its structure, it expands or “swells.” (Karpinski, 2015; Chen et al., 2022). Thus, contact of a clay layer with any water can affect the integrity and/or the productivity of an oil well and gas well. For example, water introduction into the clay during drilling and consequent clay swelling may permit dispersion of clay cuttings into a drilling fluid or recovered oil and render it difficult to remove by simpler and more cost-effective means. Clay swelling can also lead to wall instability in the well. There are other situations where swelling and disintegration of clay particulate matter can cause problems in water containing fluids. For example, clay-containing fines present in fracturing fluids comprising water may swell and become dispersed, which impairs fluid flow and makes the clay difficult to remove, preventing re-use or partial recycling of the fluids. But these have been replaced by water-based drilling fluids in efforts to reduce environmental and economic impacts.

It is therefore highly desirable to provide further additives for water-containing drilling fluids which reduce clay swelling and/or disintegration of clay containing cuttings. However, the introduction of water-based fluids into well drilling operations increases the potential for clay hydration and swelling. (Muhammed et al., 2021).

Traditionally, inhibition of clay swelling resulting from water-based drilling fluids was achieved using high concentrations of potassium chloride in the water-based fluids. However high treat rates of 3 to 7 wt % are needed which can affect the consistency of the drilling fluid and increase costs (including costs associated with disposal of fluids that contain high contents of potassium chloride). In addition, more recent studies have identified adverse environmental impacts of high concentrations of aqueous potassium chloride against some species of salmonid fish. (Densmore et al., USGS 2018).

Certain amines have been employed as alternatives to potassium chloride, with ammonium ions functioning in a similar way to potassium ions. (Horton, et al., U.S. Pat. No. 5,771,971) However, one of the problems with these additives is that they are only compatible with acidic fluids. In an attempt to overcome the need for an acidic environment, some quaternary ammonium salts have been disclosed as alternatives to amines as clay swelling inhibitors. (Murtaza, et al. 2020); (Aften et al., U.S. Pat. No. 5,342,530); Smith et al., U.S. Pat. No. 7,915,202).

More recently, the search for water-based fluid additives has focused on nanoparticles and their potential impact on drilling fluid thermal and filtration properties as well as their possible effects on rheology, fluid loss control and mud cake thickness. (Cheraghian, 2021). A range of different types of nano-additives, including polymer, ceramic, clay, silica, metal oxide, carbon-based and metal nanoparticles have been examined for impacts on one or more drilling fluid performance properties, such as their mechanical or thermal properties and wellbore stability. In some instances, nanoparticles have been postulated to reduce the cost and levels of materials in use, improve the ability to drill in challenging formations, decrease non-productive well downtime, or increase oil recovery, any of which might provide environmental and/or economic benefits in oilfield application.

Therefore, new and better clay swelling inhibitors for use within aqueous drilling fluids are needed that can reduce clay swelling, have higher penetration rates than oil-based fluids, are more environmentally acceptable, employable at much lower concentrations, are reusable, may be used in a wider range of drilling fluids including, for example, seawater-based drilling fluids and/or more cost-effective in use are extremely desirable. The present invention is directed to these and other important ends.

### SUMMARY OF THE INVENTION

Accordingly, the present invention is directed, in part, to clay stabilizing compounds consisting essentially of a metal-doped carbon quantum dot; wherein the metal species consists essentially of a Ni or Pd species or combination of Ni and Pd species, and optionally, a carbon quantum dot-metal ligand linker thereof.

In some embodiments, the present invention is directed, in part, to clay swelling inhibitor compounds consisting essentially of a metal-doped carbon quantum dot; wherein the metal species consists essentially of a Ni or Pd species or combination of Ni and Pd species, and optionally, a carbon quantum dot-metal ligand linker thereof.

In other embodiments, the present invention is directed, in part, to oilfield drilling fluid compositions comprising:
Water; and
a clay stabilizing compound consisting essentially of a metal-doped carbon quantum dot;
   wherein the metal species consists essentially of a Ni or Pd species or combination of Ni and Pd species, and optionally, a carbon quantum dot-metal ligand linker thereof.

In yet other embodiments, the present invention is directed, in part, to methods for stabilizing clay in an oilfield drilling fluid comprising water, the method comprising adding to the oilfield drilling fluid a clay stabilizing compound consisting essentially of a metal-doped carbon quantum dot;
wherein the metal species consists essentially of a Ni or Pd species or combination of Ni and Pd species, and optionally, a carbon quantum dot-metal ligand linker thereof.

In still other embodiments, the present invention is directed, in part, to methods for stabilizing clay in an oilfield drilling fluid comprising water, the method comprising adding to the oilfield drilling fluid an oilfield drilling fluid composition comprising:
Water; and
a clay stabilizing compound consisting essentially of a metal-doped carbon quantum dot;
   wherein the metal species consists essentially of a Ni or Pd species or combination of Ni and Pd species, and optionally, a carbon quantum dot-metal ligand linker thereof.

In other embodiments, the present invention is directed, in part, to methods for stabilizing clay in an oilfield drilling fluid, wherein the addition of the clay stabilizing compound disclosed hereinabove increases the clay stabilization of the oilfield drilling fluid.

In other embodiments, the present invention is directed, in part, to methods for stabilizing clay in an oilfield drilling fluid, wherein the addition of the drilling fluid composition disclosed hereinabove increases the clay stabilization of the oilfield drilling fluid.

In yet other embodiments, the present invention is directed, in part, use of a clay stabilizing compound consisting essentially of a metal-doped carbon quantum dot; wherein the metal species consists essentially of a Ni or Pd species or combination of Ni and Pd species, and optionally, a carbon quantum dot-metal ligand linker thereof as a clay swelling inhibitor in an oilfield drilling operation.

In some other embodiments, the present invention is directed, in part, to use of an oilfield drilling fluid composition comprising:
Water; and
a clay stabilizing compound consisting essentially of a metal-doped carbon quantum dot
   wherein the metal species consists essentially of a Ni or Pd species or combination of Ni and Pd species, and optionally, a carbon quantum dot-metal ligand linker thereof as a clay swelling inhibitor in an oilfield drilling operation.

The foregoing and other objectives, features, and advantages of the invention will be more readily understood upon consideration of the following detailed description of the invention.

### BRIEF DESCRIPTION OF THE DRAWINGS

FIG. 1 shows the Transmission Electron Microscopy image of Pd-doped carbon quantum dots obtained in Example 1.

FIG. 2 shows the fluorescence spectrum of Pd-doped carbon quantum dots obtained in Example 1.

FIG. 3 shows the Transmission Electron Microscopy image of Ni-doped carbon quantum dots obtained in Example 4.

FIG. 4 shows the fluorescence spectrum of Ni-doped carbon quantum dots obtained in Example 4.

### DETAILED DESCRIPTION OF ILLUSTRATIVE EMBODIMENTS

As employed above and throughout the disclosure of the present invention, the following terms, unless otherwise indicated, shall be understood to have the following meanings.

As used herein, the term “nanoparticle” refers to fine particles having a particle size of less than or equal to 100 nanometers (i.e., less than or equal to 0.1 μm)

As used herein, “about” will be understood by persons of ordinary skill in the art and will vary to some extent on the context in which it is used. If there are uses of the term which are not clear to persons of ordinary skill in the art given the context in which it is used, “about” will mean up to plus or minus 10% of the particular term.

As used in the specification and the appended claims, the singular forms “a”, “an,” and “the” include both singular and plural referents unless the context clearly dictates otherwise.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, Band C in combi-nation; or A, B, and C in combination.

Throughout this specification, the term “comprising” or “comprises” means including the component(s) specified but not to the exclusion of the presence of other components.

As used, herein, the term “carbon quantum dot-metal ligand linker” refers to one or more atoms in a chain wherein one terminus of the chain is attached to functionality that is part of the carbon quantum dot structure and the other terminus is associated with the metal species. For example, the functionality that is part of the carbon quantum dot structure may be a pendant carboxylic acid group. Thus, one of the two functional groups (OH and NH2) on monoethanolamine may react with the carboxylic acid group to form a covalent ester or amide linage, respectively. The other functional group would be available to associate with the metal species, typically ionically, covalently or coordinatively attached creating a bridge, indirectly connecting the metal species to the carbon quantum dot. In the absence of a linker ligand, the metal species may be deposited directly onto the carbon quantum dot, or directly and typically ionically, covalently or coordinatively attach itself to functionality that is a part of the carbon quantum dot structure.

As used herein, the term “clarified fruit juice” is typically an amount of juice that is prepared by crushing a fruit containing citric acid and one or more fruit sugars that is thereafter filtered to remove cellular material by means known to those in the art.

The invention illustratively disclosed herein suitably may be practiced in the absence of any element which is not specifically disclosed herein. The invention illustratively disclosed herein suitably may also be practiced in the absence of any element which is not specifically disclosed herein and that does not materially affect the basic and novel characteristics of the claimed invention.

When ranges are used herein for physical properties, such as molecular weight, particle size, or chemical properties, such as chemical formulae, contacting times of reagents, pressures, temperatures, and drying times, all combinations and subcombinations of ranges and specific embodiments therein are intended to be included.

As used herein, unless otherwise expressly specified, all numbers such as those expressing values, ranges, amounts of percentages may be read as if prefaced by the word “about”, even if the term does not expressly appear.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The optional features set out herein may be used either individually or in combination with each other where appropriate and particularly in the combinations as set out in the accompanying claims. The optional features for each exemplary aspect of the invention, as set out herein are also applicable to any other aspects or exemplary aspects of the invention, where appropriate. In other words, the skilled person reading this specification should consider the optional features for each aspect or embodiment of the invention as interchangeable and combinable between different aspects of the invention.

The disclosures of each patent, patent application and publication cited or described in this document are hereby incorporated herein by reference, in their entirety.

This invention is directed to, inter alia, the surprising and unexpected discovery of a new class of clay stabilizing compounds and compositions containing clay stabilizing compounds.

This invention is further directed to, inter alia, processes for their preparation of clay stabilizing compounds and compositions containing clay stabilizing compounds and methods of their use.

More particularly, this invention is directed, in part, to clay stabilizing compounds consisting essentially of a metal-doped carbon quantum dot. Generally speaking, the compound's ability to stabilize clay or inhibit clay swelling is not typically a function of the oxidation state of the metal atom in the metal-doped quantum carbon dot. The oxidation state of the metal species is more typically dependent on whether the metal is deposited onto the carbon quantum dot, covalently attached through a functionality present at the carbon quantum dot surface, or associated with a ligand linker group that connects the metal species to the carbon quantum dot. Yet in some embodiments of the present invention, the oxidation state (valency) of the one or more attached metal species after doping is zero. In other embodiments the metal species' valency is two. In still further embodiments, the one or more attached metal species may include metal species having combination of valency states (zero and two).

Benefits of the clay stabilizing compounds and compositions containing clay stabilizing compounds of the present invention include one or more of: an ability to reduce clay swelling, have higher penetration rates than oil-based fluids, be more environmentally acceptable and/or employable at much lower concentrations, are reusable, may be used in a wider range of drilling fluids including, for example, seawater-based drilling fluids and/or more cost-effective in use.

Accordingly, in certain embodiments, the present invention provides clay stabilizing compounds consisting essentially of a metal-doped carbon quantum dot; wherein the metal species comprises a Ni or Pd species or combination of Ni and Pd species, and optionally, a carbon quantum dot-metal ligand linker thereof. In certain preferred embodiments, the metal-doped carbon quantum dot may include one or more further metal species. In other preferred embodiments, the metal-doped carbon quantum dot as disclosed above excludes one or more of the following metal species: zinc, iron, cobalt, chromium, manganese, magnesium, copper, molybdenum, ruthenium, rhodium, silver, tungsten, rhenium, osmium, gadolinium, iridium, platinum or gold as a further metal species in the metal-doped carbon quantum dot.

In certain other embodiments, the present invention provides clay stabilizing compounds consisting essentially of a metal-doped carbon quantum dot; wherein the metal species consists essentially of a Ni or Pd species or combination of Ni and Pd species, and optionally, a carbon quantum dot-metal ligand linker thereof.

In still other embodiments, the present invention provides clay stabilizing compounds consisting essentially of a metal-doped carbon quantum dot; wherein the metal species consists of a Ni or Pd species or combination of Ni and Pd species, and optionally, with a carbon quantum dot-metal ligand linker thereof between the carbon quantum dot and the metal species.

In certain preferred embodiments of the compounds according to the invention, the metal species in the metal-doped carbon quantum dot is a nickel species. In other preferred embodiments, the metal species is a palladium species. In still other preferred embodiments, the metal species is a combination of nickel and palladium species on a carbon quantum dot, or alternatively a mixture of nickel-doped quantum dots and palladium-doped quantum dots. In some preferred embodiments, the metal species is deposited directly onto the carbon quantum dot. In other preferred embodiments, the metal species is covalently, ionically or coordinatively attached to a functionality present at the surface of the carbon quantum dot.

In certain other preferred embodiments, the metal and the carbon quantum dot are linked together by a ligand that indirectly connects the metal species and the carbon quantum dot. The ligand linker is attached at one end of its chain structure to the carbon quantum dot, typically covalently through a functionality at the surface of the carbon quantum dot. The other terminus of the ligand may be connected to the metal through a coordinate bond, for example, a metal chelating functionality, or through a covalent or ionic bond, as one of ordinary skill in the art would readily appreciate.

In certain preferred embodiments, the metal-doped carbon quantum dot has a fluorescence emission maximum from about 425 nm to about 500 nm. In other preferred embodiments, the metal-doped carbon quantum dot has a fluorescence emission maximum from about 425 nm to about 475 nm. In yet other preferred embodiments, the particle size of the metal-doped carbon quantum dot is in a range of from about 1 nm to about 15 nm, characterized by transmission electron microscopy.

In some preferred embodiments, the clay stabilizing compounds are provided as oilfield drilling fluid compositions comprising the clay stabilizing compound disclosed hereinabove and water. In other preferred embodiments, the compositions further comprise a co-solvent. In some preferred embodiments, the co-solvent is a glycol. In certain embodiments the glycol is an alkylene glycol, more preferably an ethylene glycol. Non-limiting examples include monoethylene glycol and diethylene glycol.

Some other preferred embodiments of oilfield drilling fluid compositions the water includes fresh water, seawater, or a combination of fresh water and seawater. Any of these compositions may be advantageously employed in or added to aqueous drilling fluids known in the art.

In some embodiments, the invention is directed to processes for preparing a clay stabilizing compound consisting essentially of a metal-doped carbon quantum dot; wherein the metal species consists essentially of a Ni or Pd species or combination of Ni and Pd species, and optionally, a carbon quantum dot-metal ligand linker thereof:
said process comprising:
microwave irradiating a clarified fruit juice containing citric acid and a sugar for a time and under conditions effective to prepare a carbon quantum dot containing material;
combining a nickel or palladium salt and monoethanolamine with the material; and
heating the combined material using induction heating for a time and under conditions effective to prepare the metal-doped carbon quantum dot.

In certain embodiments, the invention is directed to methods for stabilizing clay in an oilfield drilling fluid comprising water, the method comprising adding to the oilfield drilling fluid a clay stabilizing compound comprising a metal-doped carbon quantum dot, preferably wherein the metal-doped carbon quantum dot is as disclosed hereinabove.

In certain other embodiments, the invention is directed to methods for stabilizing clay in an oilfield drilling fluid comprising water, the method comprising adding to the oilfield drilling fluid a drilling fluid composition comprising water and a metal-doped carbon quantum dot, preferably wherein the water and the metal-doped carbon quantum dot are each independently as disclosed hereinabove.

In some preferred embodiments of the methods of the present invention, the addition of a clay stabilizing compound as disclosed herein to an oilfield drilling fluid increases the clay stabilization of the oilfield drilling fluid.

In yet other preferred embodiments of the methods of the present invention, the addition of a drilling fluid composition as disclosed herein to an oilfield drilling fluid increases the clay stabilization of the oilfield drilling fluid.

Once armed with the disclosures provided herein, the skilled artisan will be able to appreciate and employ to great advantage the metal-doped carbon quantum dots and their compositions, methods, techniques and processes disclosed herein for use within aqueous drilling fluids that can reduce clay swelling, have higher penetration rates than oil-based fluids, are more environmentally acceptable, employable at much lower concentrations, are reusable, may be used in a wider range of drilling fluids including, for example, seawater-based drilling fluids and/or more cost-effective in use are extremely desirable.

The present invention is further described in the following examples. Excepted where specifically noted, the examples are actual examples. These examples are for illustrative purposes only, and are not to be construed as limiting the appended claims.

### EXPERIMENTAL SECTION

### Examples of the Present Invention

### Example 1

### Preparation of Carbon Quantum Dots (CQD)

Cape Gooseberry citrus (Physalis peruviana, 2000 grams) from a local market in Rio Negro Antioquia was crushed in a juice extractor (Oster model 3169). The resultant juice was clarified by filtration with a Tecnal Filtration Apparatus (0.22 μm pore size filter). The clarified juice was analyzed for total sugars content and citric acid content (7.61 g of total sugars/100 mL juice, and 1.30 g citric acid/100 mL juice). The clarified juice (800 grams) was microwaved for 270 minutes in an Haceb ASHM 1.1ME microwave oven at 300 watts and 2450 Mhz. The microwaved intermediate was mixed with monoethanolamine (50 grams, Merck) and Palladium nitrate dihydrate ([Pd(NO3)2 2H2O], 2 grams) sourced from Proferro Fenandez SAS¹, gently stirred and homogenized in a 316 stainless-steel vessel. The mixture was then radiated for 25 minutes in a Mini-melt Inductotherm at 2500 watts and 3000 hertz to a temperature of 120° C. The CQD was collected for further characterization.

### Example 2

### Characterization of Quantum Dots:

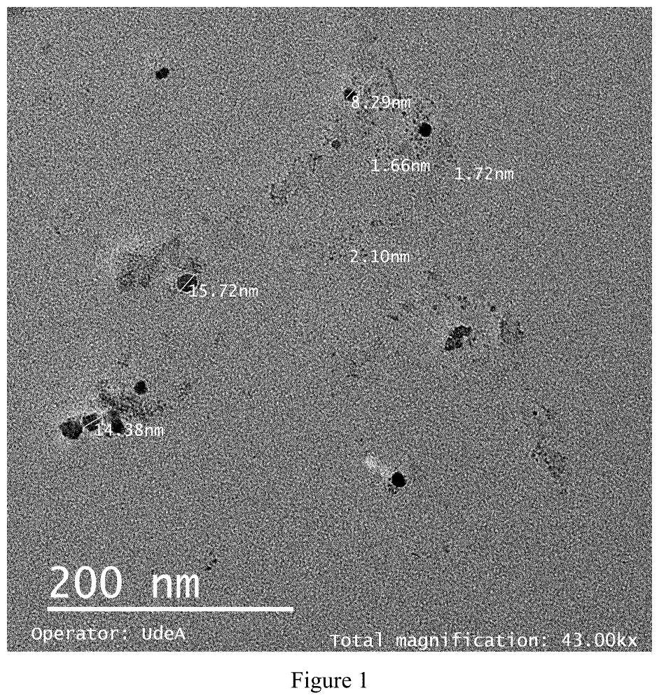

A sample of Carbon Quantum Dots obtained in Example 1 was characterized by Transmission Electron Microscopy (FEI Tecnai F20 Super Twin TMP at a total magnification of 43 KX and a resolution of 0.14 nm. The Transmission Electron Microscopy (TEM) image of the Carbon Quantum Dots prepared in Example 1 is shown in FIG. 1. The size range of the Quantum Dot nanoparticles was from about 1 nm to about 15 nm.

### Example 3

### Fluorescence Spectroscopy of Quantum Dots

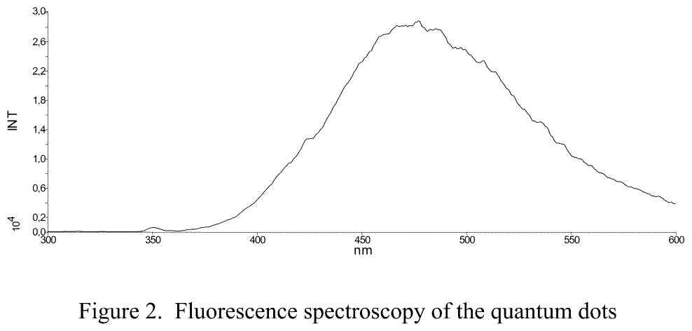

A sample of Carbon Quantum Dots (100 mg) obtained in Example 1 was poured into beaker containing deionized water (100 mL). The fluorescence spectroscopy of the prepared solution of carbon quantum dots was measured using a PerkinElmer LS-6500 Fluorescence Spectrometer. The resultant spectrum is presented in FIG. 2.

### Example 4

Cape Gooseberry citrus (Physalis peruviana, 2000 grams from a local market in Rio Negro Antioquia was crushed in a juice extractor (Oster model 3169). The resultant juice was clarified by filtration with a Tecnal Filtration Apparatus (0.22 μm pore size filter). The clarified juice was analyzed for total sugars content and citric acid content (7.61 g of total sugars/100 mL juice, and 1.30 g citric acid/100 mL juice). The clarified juice (800 grams) was microwaved for 270 minutes in an Haceb ASHM 1.1ME microwave oven at 300 watts and 2450 Mhz. The microwaved intermediate was mixed with monoethanolamine (50 grams, Merck) and Nickel nitrate hexahydrate ([(Ni(NO3)2·6 H2O)], 2 grams) sourced from Proferro Fenandez SAS², gently stirred and homogenized in a 316 stainless-steel vessel. The mixture was then radiated for 25 minutes in a Mini-melt Inductotherm at 2500 watts and 3000 hertz to a temperature of 120° C. The CQD was collected for further characterization.

### Example 5

### Characterization of Quantum Dots

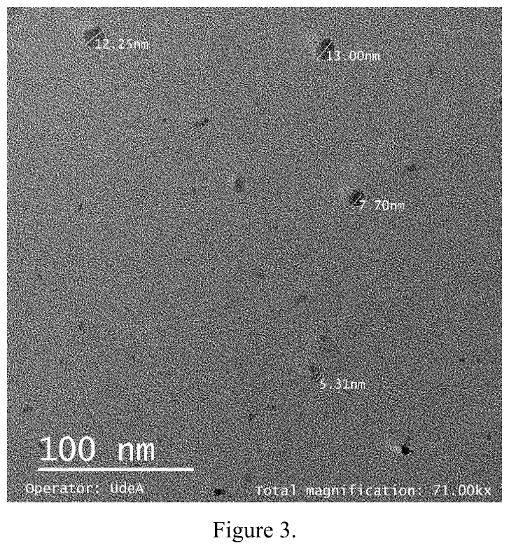

A sample of Carbon Quantum Dots obtained in Example 4 was characterized by Transmission Electron Microscopy (FEI Tecnal F20 Super Twin TMP at a total magnification of 43 KX and a resolution of 0.14 nm. The Transmission Electron Microscopy (TEM) image of the Carbon Quantum Dots prepared in Example 4 is shown in FIG. 3. The size range of the Quantum Dot nanoparticles was from about 5 nm to about 13 nm.

### Example 6

### Fluorescence Spectroscopy of Quantum Dots

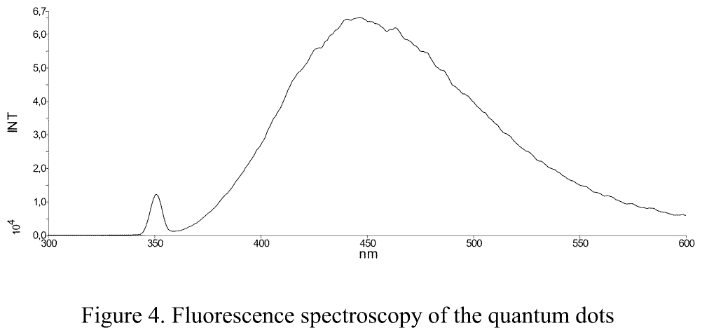

A sample of Carbon Quantum Dots (100 mg) obtained in Example 4 was poured into a beaker containing deionized water (100 mL). The fluorescence spectroscopy of the prepared solution of carbon quantum dots was measured using a PerkinElmer LS-6500 Fluorescence Spectrometer. The resultant spectrum is presented in FIG. 4.

### Example 7

Dry clay samples supplied by Petrorocas³ of smectite (40 grams), illite (17 grams), Montmorillonite (1 gram), Kaolinite (17 grams), Quartz (25 grams) were mixed together gently until homogenized and subsequently weighed into portions (2 grams) for preparing clays-tablets. The clay mixture portions were individually placed in a tablet compacter and compressed using 40 MPa of pressure and stored in a dry environment.

### Example 8

Five clay tablets obtained in example 7 were each independently measured before swelling test. The clay tablets were allowed to stand for 1 hour in one of the prepared solutions listed in Table 1 to hydrate and swell the clay. The aqueous solutions contained either deionized water or a deionized water solution having a CQD obtained in Example 1 or Example 4 at the specified loading. The swelling of each clay-tablet was measured and reported in Table 1.

TABLE 1

| Clay | | Clay Swelling % |
|---|---|---|
| Tablet | Aqueous solution | (expansion⁴) |
| # 1 | Deionized Water | 253% |
| #2 | Deionized water + 0.5% w/w Ni | 19.1% |
| | loaded CQD | |
| #3 | Deionized water + 1.0% w/w Ni | 17% |
| | loaded CQD | |
| #4 | Deionized water + 0.5% w/w Pd | 38.3% |
| | loaded CQD | |
| #5 | Deionized water + 1.0% w/w Pd | 33.1% |
| | loaded CQD | |

Five clay tablets obtained in Example 7 were each independently measured before swelling test. The clay tablets were allowed to stand for 1 hour in one of the prepared solutions listed in Table 2 to hydrate and swell the clay. The aqueous solutions contained either seawater water or a seawater solution having a CQD obtained in Example 1 or Example 4 at the specified loading. The swelling of each clay-tablet was measured and reported in Table 2.

TABLE 2

| | | Clay Swelling % |
|---|---|---|
| Clay Tablet | Aqueous solution | (expansion) |
| # 6 | Seawater | 71% |
| #7 | Seawater + 0.5% w/w Ni loaded CQD | 12.7% |
| #8 | Seawater + 1.0% w/w Ni loaded CQD | 9.4% |
| #9 | Seawater + 0.5% w/w Pd loaded CQD | 32.1% |
| #10 | Seawater + 1.0% w/w Pd loaded CQD | 25.4% |

Embodiment 1. A clay stabilizing compound consisting essentially of a metal-doped carbon quantum dot; wherein the metal-doped carbon quantum dot's metal species consists essentially of a Ni or Pd species or combination of Ni and Pd species, and optionally, a carbon quantum dot-metal ligand linker thereof.
Embodiment 2. A compound according to Embodiment 1, wherein the metal species is deposited onto or ionically, covalently or coordinatively attached, directly or indirectly to a functionality on the carbon quantum dot.
Embodiment 3. A compound according to Embodiment 1 or 2, wherein the metal species consists essentially of a Ni species, and optionally, a carbon quantum dot-metal ligand linker thereof.
Embodiment 4. A compound according to Embodiment 1 or 2, wherein the metal species consists essentially of a Pd species, and optionally, a carbon quantum dot-metal ligand linker thereof.
Embodiment 5. A compound according to Embodiment 1, 2, 3 or 4 wherein the metal species is deposited onto the carbon quantum dot.
Embodiment 6. A compound according to Embodiment 1, 2, 3 or 4 wherein the metal species is ionically, covalently or coordinatively attached, directly or indirectly to a functionality on the carbon quantum dot.
Embodiment 7. A compound according to Embodiment 1, 2, 3, 4, or 6, wherein the carbon quantum dot-metal ligand linker is covalently bonded to the carbon quantum dot.
Embodiment 8. A compound according to Embodiment 1, 2, 3, 4, or 6, wherein the metal is chelated to a functionality on the carbon quantum dot or to the linker.
Embodiment 9. A compound according to Embodiment 1, 2, 3, 4, 5, 6, 7, or 8 wherein the particle size of the metal-doped quantum dot is in a range of from about 1 to about 15 nm as characterized by transmission electron microscopy.
Embodiment 10. A compound according to Embodiment 1, 2, 3, 4, 5, 6, 7, 8, or 9 wherein the metal-doped quantum dot has a fluorescence maximum in a range of from about 425 to about 475 nm.
Embodiment 11. An oilfield drilling fluid composition comprising:
Water; and
the clay stabilizing compound according to Embodiment 1, 2, 3, 4, 5, 6, 7, 8, 9, or 10.
Embodiment 12. An oilfield drilling fluid composition according to Embodiment 11, further comprising a co-solvent.
Embodiment 13. A composition according to Embodiment 11 or 12, wherein the water is seawater.
Embodiment 14. A method for stabilizing clay in an oilfield drilling fluid comprising water, the method comprising adding to the oilfield drilling fluid the clay stabilizing compound according to Embodiment 1, 2, 3, 4, 5, 6, 7, 8, 9, or 10.
Embodiment 15. A method for stabilizing clay in an oilfield drilling fluid comprising water, the method comprising adding to the oilfield drilling fluid the drilling fluid composition according to Embodiment 11, 12, or 13.
Embodiment 16. A method for stabilizing clay in an oilfield drilling fluid comprising water according to Embodiment 14, wherein the addition of the clay stabilizing compound increases the clay stabilization of the oilfield drilling fluid.
Embodiment 17. A method for stabilizing clay in an oilfield drilling fluid according to Embodiment 15, wherein the addition of the drilling fluid composition compound increases the clay stabilization of the oilfield drilling fluid.

When any variable occurs more than one time in any constituent or in any formula, its definition in each occurrence is independent of its definition at every other occurrence. Combinations of substituents and/or variables are permissible only if such combinations result in stable compositions.

It is believed the chemical formulas, abbreviations, and names used herein correctly and accurately reflect the underlying compounds reagents and/or moieties. However, the nature and value of the present invention does not depend upon the theoretical correctness of these formulae, in whole or in part. Thus it is understood that the formulas used herein, as well as the chemical names and/or abbreviations attributed to the correspondingly indicated compounds, are not intended to limit the invention in any way, including restricting it to any specific form or to any specific isomer.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

What is claimed:

1. A clay stabilizing compound consisting essentially of a metal-doped carbon quantum dot; wherein the metal-doped carbon quantum dot's metal species consists essentially of a Ni or Pd species or combination of Ni and Pd species, and optionally, a carbon quantum dot-metal ligand linker thereof.

2. A compound according to claim 1, wherein the metal species is deposited onto or ionically, covalently or coordinatively attached, directly or indirectly to a functionality on the carbon quantum dot.

3. A compound according to claim 1, wherein the metal species consists essentially of a Ni species, and optionally, a carbon quantum dot-metal ligand linker thereof.

4. A compound according to claim 1, wherein the metal species consists essentially of a Pd species, and optionally, a carbon quantum dot-metal ligand linker thereof.

5. An oilfield drilling fluid composition comprising:
Water; and
the clay stabilizing compound according to claim 1.

6. An oilfield drilling fluid composition according to claim 5, further comprising a co-solvent.

7. A method for stabilizing clay in an oilfield drilling fluid comprising water, the method comprising adding to the oilfield drilling fluid the clay stabilizing compound according to claim 1.

8. A method for stabilizing clay in an oilfield drilling fluid comprising water, the method comprising adding to the oilfield drilling fluid the drilling fluid composition according to claim 5.

9. A composition according to claim 5, wherein the water is seawater.

10. A compound according to claim 2, wherein the metal species is deposited onto the carbon quantum dot.

11. A compound according to claim 2, wherein the metal species is ionically, covalently or coordinatively attached, directly or indirectly to a functionality on the carbon quantum dot.

12. A method for stabilizing clay in an oilfield drilling fluid according to claim 7, wherein the addition of the clay stabilizing compound increases the clay stabilization of the oilfield drilling fluid.

13. A method for stabilizing clay in an oilfield drilling fluid according to claim 8, wherein the addition of the drilling fluid composition compound increases the clay stabilization of the oilfield drilling fluid.

14. A compound according to claim 3, wherein the metal-doped quantum dot has a fluorescence maximum in a range of from about 425 to about 475 nm.

15. A compound according to claim 1, wherein the carbon quantum dot-metal ligand linker is covalently bonded to the carbon quantum dot.

16. A compound according to claim 1, wherein the metal is chelated to a functionality on the carbon quantum dot or to the linker.

17. A compound according to claim 15, wherein the metal is chelated to a functionality on the carbon quantum dot or to the linker.

18. A compound according to claim 1, wherein the particle size of the metal-doped quantum dot is in a range of from about 1 to about 15 nm as characterized by transmission electron microscopy.
